(19) United States
(12) Patent Application Publication
(10) Pub. No.: US 2003/0052003 A1
(43) Pub. Date: Mar. 20, 2003

(54) Cast analyte diffusion-limiting membranes using photopolymerizable hydrophylic monomers

(76) Inventors: Kelly Patrick, Chamblee, GA (US); Jarad Schiffner, Atlanta, GA (US)

Correspondence Address: MERCHANT & GOULD PC, P.O. BOX 2903, MINNEAPOLIS, MN, 55402-0903, US

(21) Appl. No.: 10/182,767

(22) PCT Filed: Feb. 1, 2001
(86) PCT No.: PCT/US01/03304

(51) Int. Cl. G01N 27/327

(52) U.S. Cl. 204/403.11

(57) ABSTRACT

The present invention provides a diffusion limiting membrane system for filtering an analyte from a fluid, comprising: a) a first layer comprising an analyte responsive enzyme; and b) a second layer comprising a water-soluble monomer composition, wherein the first layer is in direct contact with one or more sensor electrodes and the second layer is in direct contact with the first layer.

### CROSS REFERENCE TO RELATED APPLICATIONS

This application claims priority to U.S. Provisional Application Serial No. 60/179,716, filed Feb. 1, 2000, which application is incorporated herein by this reference in its entirety.

### FIELD OF INVENTION

The present invention relates in general to a diffusion-limiting hydrogel membrane system for use in analyte detection systems. More specifically, the present invention relates to cast analyte diffusion-limiting hydrogel membranes for filtering an analyte from fluids, comprising a water soluble photopolymerizable hydrophilic hydrogel monomer, capable of limiting the amount of analyte that will react with an analyte responsive enzyme and thus, further enabling a detection device to operate on a discrete basis or continually over an extended period of time.

### SUMMARY OF THE INVENTION

The present invention provides a diffusion-limiting hydrogel membrane system for filtering analytes or other desired characteristics from a fluid. The hydrogel membrane system can be employed in a detection device wherein the diffusion-limiting hydrogel membrane operates to regulate the amount of analyte that is present at the sensor electrodes at any given time, thus, allowing the sensor electrodes to operate on a discrete basis or continuously over longer periods of time without substantially depleting the amount of reactant present on the sensor electrodes.

Additional advantages of the invention will be obvious from the description, or may be learned by practice of the invention. Additional advantages of the invention will also be realized and attained by means of the elements and combinations particularly pointed out in the appended claims. It is to be understood that both the foregoing general description and the following detailed description are exemplary and explanatory of certain embodiments of the invention, and are not restrictive of the invention as claimed.

### BRIEF DESCRIPTION OF DRAWINGS

FIG. 1A illustrates a cross sectional view of an assay device containing one embodiment of a cast analyte diffusion limiting membrane according to the present invention.

FIG. 1B illustrates a front view of an assay device containing one embodiment of a cast analyt diffusion limiting member Tc-cording to t invention.

FIG. 2 is a graph indicating the results of example 1.

FIG. 3 is a graph indicating the results of example 2.

### DETAILED DESCRIPTION OF THE INVENTION

The present invention may be understood more readily by reference to the following figures and their previous and following description, including the detailed description of the invention and any examples provided herein. It is to be understood that this invention is not limited to the specific embodiments and methods described, as specific components and/or conditions may, of course, vary. It is also to be understood that the terminology used herein is for the purpose of describing particular embodiments only and is not intended to be limiting in any way.

It must also be noted that, as used in the specification and the appended claims, the singular forms “a,” “an,” and “the” comprise plural referents unless the context clearly dictates otherwise. For example, reference to a component in the singular is intended to comprise a plurality of components.

Ranges may be expressed herein as from “about” or “approximately” one particular value and/or to “about” or “approximately” another particular value. When such a range is expressed, another embodiment comprises from the one particular value and/or to the other particular value. Similarly, when values are expressed as approximations, by use of the antecedent “about,” it will be understood that the particular value forms another embodiment.

As used herein, “analyte” shall mean the component that is being filtered from a liquid or gas and/or detected and/or measured in a detection device. In situationswhere an analyte is being filtered from a biological fluid, the analyte can include without limitation, glucose, acetoacetate, ammonia, catecholamines, creatine, creatinine, fructose, galactose, β-hydroxybutyric acid, bilirubin, lactate, lactic acid, amino acids, urea, uric acid, salicylates, pH, magnesium, calcium, lithium, lead, potassium, sodium, chloride, iron, and any other electrolyte, vitamin, protein, nutrient, pharmaceutical compounds, or other such characteristic desired.

As used herein, the term “electrolyte” means a chemical compound that ionizes when dissolved to produce an electrically conductive medium.

As used herein, the term “fluid” means a liquid or a gas.

As used herein, the term “biological fluid” means blood serum, whole blood, interstitial fluid, lymph fluid, spinal fluid, plasma or any combinations of these fluids. “Interstitial fluid” further refers to the clear fluid that occupies the space between the cells in the body.

As used herein, the term “biological membrane” means the outer layer of an organism, such as skin or mucous membrane, the structure separating one area of an organism from another, such as a capillary wall, or the outer layer of an organism which separates the organism from its external environment, such as skin, buccal mucosa or other mucous membrane.

As used herein, the term “hydrogel” means a polymeric material that can absorb 20% or more of its weight in water while simultaneously maintaining a distinct three-dimensional structure. More specifically, the hydrogels according to the present invention can be comprised of an aerogel that dries without significant collapse of the macroscopic structure and which absorbs water into macropores without substantial macroscopic swelling or, alternatively, xerogels which absorb water by swelling. It is further envisioned by the present invention that suitable hydrogels can include dry polymers that will swell in aqueous environments. Representative examples of suitable hydrogels for use in the present invention include without limitation 2-hydroxyethyl methacrylate, N,N,-dimethacrylamide, N-vinylpyrrolidine, polyethyleneglycol dimethacrylate, and/or copolymers thereof.

As used herein, the term “cast” means a method of forming a coating over an electrode area. Representative examples can include doctor blading, spraying, and/or dipping.

As used herein, the term “diffusion-limiting hydrogel membrane” means a hydrogel that limits the flow of analytes from one space to another.

As used herein, the term “detection device” means any assay device suitable for measuring a desired characteristic of a fluid on a continual or discrete basis. An example of such device is that disclosed by international Patent Application No. PCT/US00/09393 which application is incorporated herein by this reference in its entirety.

As used herein, the term “sensor electrode” means an electrode suitable for detecting the concentration of various ions in an aqueous and/or gaseous environment. Examples of suitable sensor electrodes according to the present invention include without limitation platinumized carbon ink or platinum metal held at a given electrical potential to cause the reduction of an analyte.

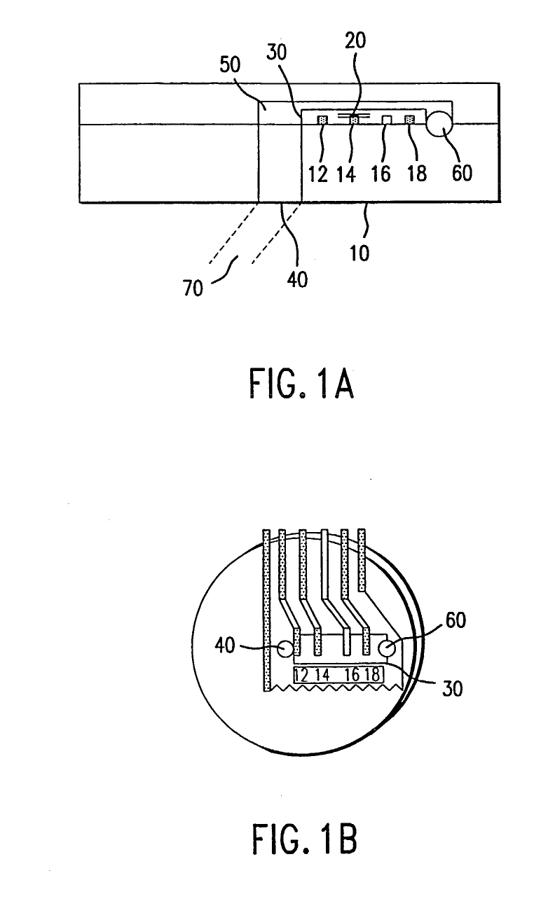

Referring to FIG. 1A, the present invention shows a cross-sectional view of a detection device 10 which operates on a continuous basis. The device 10 contains an inlet port 40 to receive fluid and a chamber 50 in fluid communication with the inlet port 40, and an outlet port 60 in fluid communication with the chamber 50, where the outlet port 60 is designed to allow the discharge of fluid.

The chamber 50 further comprises a first working sensor electrode 12, a second working sensor electrode 14, a reference electrode 16 and a counter electrode 18. A first layer of an analyte responsive enzyme 20, such as glucose oxidase, is applied to at least one of the working sensor electrodes 12 or 14. A second layer comprising a composition comprising a diffusion-limiting hydrogel membrane 30 is applied to at least one of the working sensor electrodes 12 or 14, wherein the first layer is in direct contact with at least one sensor electrode and the second layer is in direct contact with the first layer.

According to several embodiments, the device 10 of the present invention may further comprise an external channel 70, wherein one end of the external channel 70 is in fluid communication with the inlet port 40 and the other end is in fluid communication with at least one liquid and/or gas.

In an alternative embodiment, which is not shown in this figure, the analyte responsive eiizynii 20 and the composition comprising a diffusion-limiting hydrogel membrane are mixed together and applied to at least one of the working sensor electrodes 12 or 14 as a mono-layer membrane system.

FIG. 1B is a front view of the detection device 10 and is described the same as FIG. 1A above.

In one aspect, the present invention provides a diffuision limiting membrane system for filtering an analyte from a liquid, comprising:

a) a first layer comprising an analyte responsive enzyme; and

b) a second layer comprising a water-soluble monomer composition, wherein the first layer is in direct contact with one or more sensor electrodes and the second layer is in direct contact with the first layer.

In another aspect of the present invention, there is provided a diffusion-limiting hydrogel membrane system for filtering glucose from fluids comprising a glucose limiting membrane comprising a composition comprising a water soluble monomer, an enzyme, and an initiator, wherein the composition is disposed on one or more sensor electrodes and cured in the presence of sunlight or UV light.

In still another aspect, the present invention further provides a diffuision-limiting hydrogel membrane system for filtering glucose from fluids comprising a composition comprising a water soluble monomer, a cross-linking agent, an enzyme, and an initiator, wherein the composition is disposed on one or more sensor electrodes and cured in the presence of sunlight or UV light.

In another aspect, the present invention further provides a diffusion-limiting hydrogel membrane system comprising:

a) a first layer comprising an analyte responsive enzyme; and

b) a second layer comprising a water-soluble monomer composition, wherein the first layer is in direct contact with one or more sensor electrodes and the second layer is in direct contact with the first layer.

In yet a further embodiment, the present invention provides a diffusion-limiting hydrogel membrane for filtering an analyte from a fluid, comprising:

a) a first layer comprising an analyte responsive enzyme; and

b) a second layer comprising a water-soluble monomer composition, wherein the first layer is in direct contact with one or more sensor electrodes and the second layer is in direct contact with the first layer.

Suitable analytes for use with the present invention include without limitation glucose, acetoacetate, ammonia, catecholamines, creatine, creatinine, fructose, galactose, β-hydroxybutyric acid, bilirubin, lactate, lactic acid, amino acids, urea, uric acid, salicylates, pH, magnesium, calcium, lithium, lead, potassium, sodium, chloride, iron, and any other electrolyte, vitamin, protein, nutrient, pharmaceutical compounds, or other such characteristic desired.

Suitable analyte responsive enzymes for use in the diffusion-limiting hydrogel membranes of the present invention will be dependent upon the desired use of the invention. For example, in one embodiment, there is provided a diffusion-limiting hydrogel membrane system for filtering glucose from biological fluids. In this environment, the glucose responsive enzyme is glucose oxidase, which is available from Sigma. However, to this end, any appropriate enzyme recognized for use in detecting glucose could be employed.

In still another embodiment, the analyte responsive enzyme is dissolved in deionized water or phosphate buffered de-ionized water. The phosphate buffer system (PBS) acts to maintain the analyte responsive enzyme at a pH value within the range of normal physiological levels. According to the present invention, the analyte responsive enzyme can be dissolved in an amount of from about 1 mg/mL to about 100 mg/mL. In another embodiment, the enzyme is dissolved in an amount of from about 1 mg/mL to about 50 mg/mL. In still a further embodiment of the present invention, the enzyme can be dissolved in an amount of from about 1 mg/mL to about 10 mg/mL.

Suitable water soluble monomers for use in the present include 2-hydroxyethyl methacrylate, N,N,-dimethacrylamide, N-vinylpyrrolidine, polyethyleneglycol dimethacrylate, and/or copolymers thereof. According to one embodiment, the water-soluble monomers for use in the inventive membranes are highly water permeable hydrogels, such as 2-hydroxyethyl methacrylate (HEMA).

In one embodiment, the water soluble monomer of the present invention is diluted in an aqueous medium. By diluting the hydrogel membrane in an aqueous medium it enables the membrane system to be cast onto sensitive or delicate substrates that ordinarily cannot tolerate the harshness of organic solvents. In one embodiment, the hydrogel monomers of the present invention can be diluted in the aqueous medium at a range of dilution from about 0.01% to about 50% by volume. In another embodiment, the range of dilution is from about 0.05% to about 10% by volume. In still a further embodiment, the range of dilution is from about 0.1% to about 5% by volume.

In another embodiment, the water soluble monomer of the present invention can further comprise one or more initiators. Any water soluble UV or thermal initiators known in the art can be used with the present invention. Representative examples of suitable initiators for use in the invention include 2,2 dimethoxy-2-phenylacetophenone, Vazo 52®, available from DuPont, and Vazo 64®, also available from DuPont. In one embodiment, the initiator is introduced into the water soluble monomer in an amount of from about 1 to about 10% by weight. In another embodiment, the initiator is introduced into the water soluble monomer in an amount of from about 2 to about 5% by weight.

In one embodiment, the water soluble monomer of the present invention can be cast or cured directly onto an electrode in the presence of sunlight or ultraviolet light without requiring the use of an adhesive or special processing to further protect an enzyme within the system.

In another embodiment, the water soluble monomer composition further comprises water soluble cross-linking agents. In this embodiment, the cross-linking agent can participate in the polymerization of the water soluble monomer and thus facilitate the formation of the desired hydrogel membrane. Examples of suitable cross-linking agents for use in the present invention include without limitation polytheyleneglycol dimethacryalate and/or gluteraldehyde. To this end, any water soluble free radical cross-linking agents can be used in the present invention. The cross-linking agents can be introduced into the water soluble monomer in an amount of from about 1 to about 10% by volume. In another embodiment, the cross-linking agent can be introduced into the water soluble monomer in an amount of from about 2 to

In one embodiment, the thickness of the membranes of the present invention is from about 2 to about 50 micrometers. In another embodiment, the thickness of the membrane is from about 2 to about 25 micrometers. In still a further embodiment, the thickness of the membrane is from about 2 to about 20 micrometers.

### EXAMPLES

### Example 1

Example 1 relates to a bi-layer diffusion-limiting hydrogel membrane system for filtering glucose from biological fluids. First, solution 1 was prepared, and consisted of 1000 μl of 2-hydroxyethyl methacrylate and 4% by weight of a UV initiator, 2,2 Dimethoxy-2-phenylacetophenone. Then, using a detection device 10 such as the one shown in FIG. 1A, a 0.5 μl drop of solution 2, comprised of 495 μl of a phosphate buffer system (PBS), 10 μl of gluteraldehyde, 4 mg of Glucose Oxidase, and 30 mg of bovine serum albumin (BSA), was placed on at least one of the working sensor electrodes 12 or 14. This drop was allowed to dry for 12 hrs after which a 1 μl drop of solution 3, which contained 495 μl of PBS and 10 μl of solution 1, was placed on top of the drop on the at least one working sensor electrode 12 or 14. This second drop was exposed to long wave UV radiation for 0.5 hrs, wherein the radiation value was approximately 415 nm to approximately 430 nm.

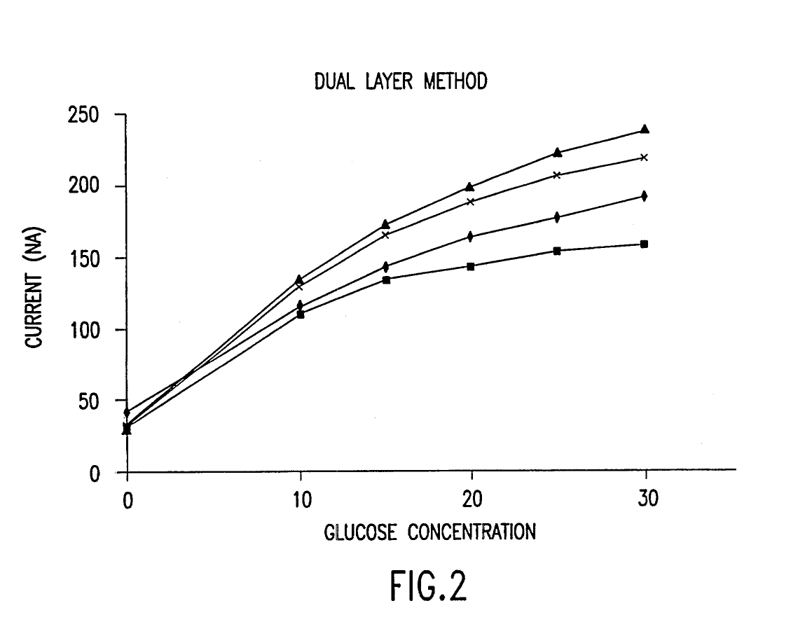

The cured hydrogel membrane was then placed in a solution of de-ionized water and PBS and tested against a series of glucose levels as seen in FIG. 2. The results for this bi-layer hydrogel membrane system are set forth in said FIG. 2, wherein it illustrates that the bi-layer diffusion limiting hydrogel membrane system of example 1 was suitable for accurately detecting glucose levels at concentrations of up to approximately 25 to 30 mM.

### Example 2

Example 2 relates to a single layer diffusion-limiting hydrogel membrane system for filtering glucose from biological fluids. First, solution 1 was prepared, and consisted of 1000 μl of 2-hydroxyethyl methacrylate and 4% by weight of 2,2 Dimethoxy-2-phenylacetophenone. Then, using a detection device 10 such as the one shown in FIG. 1A, a 0.5 μl drop of solution 2, which contained 495 μl of PBS, 4 mg of Glucose Oxidase, and 10 μl of solution 1, was placed on at least of the working sensor electrodes 12 or 14. This 0.5 μl drop was exposed to long wave UV radiation for 0.5 hrs, wherein the radiation value was approximately 415 nm to approximately 430 nm.

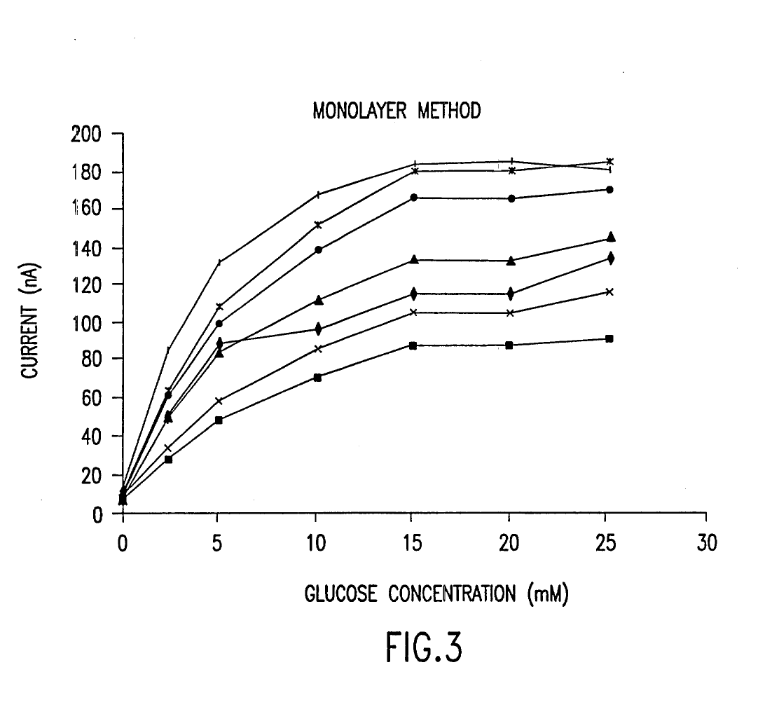

The cured membrane was then placed in a solution of de-ionized water and PBS and tested against a series of glucose levels as seen in FIG. 3. The results for this mono-layer hydrogel membrane system are set forth in said FIG. 3, wherein it illustrates that the mono-layer diffusion limiting hydrogel membrane system of example 2 was suitable for accurately detecting glucose levels at concentrations of up to approximately 10 mM.

We claim:

1. A diffusion-limiting hydrogel membrane system for filtering an analyte from a liquid, comprising:
a) a first layer comprising an analyte responsive enzyme; and
b) a second layer comprising a water-soluble monomer composition,
wherein the first layer is in direct contact with one or more sensor electrodes and the second layer is in direct contact with the first layer.

2. The membrane system of claim 1, wherein the analyte is glucose.

3. The membrane system of claim 1, wherein the analyte responsive enzyme is glucose oxidase.

4. The membrane system of claim 1, wherein the enzyme is dissolved in deionized water.

5. The membrane system of claim 1, wherein the water soluble monomer comprises 2-hydroxyethyl methacrylate, N,N-dimethylacrylamide, N-vinylpyrrolidinone, and polyethyleneglycol dimethacrylate, or co-polymers thereof.

6. The membrane system of claim 1, wherein the water-soluble monomer composition further comprises an initiator and an aqueous medium.

7. The membrane system of claim 1, wherein the membrane system is cured in the presence of sunlight or UV light.

8. The membrane system of claim 1, wherein the water-soluble monomer composition further comprises a water-soluble cross-linking agent.

9. The membrane system of claim 8, wherein the water soluble cross-linking agent is polyeythyleneglycol dimethacrylate.

10. A diffusion-limiting hydrogel membrane system for filtering glucose from fluids, comprising a glucose limiting membrane comprising a composition comprising a water soluble monomer, an enzyme, and an initiator, wherein the composition is disposed on one or more sensor electrodes and cured in the presence of sunlight or UV light.

11. A diffusion-limiting hydrogel membrane system for filtering glucose from fluids, comprising a composition comprising a water soluble monomer, a cross-linking agent, an enzyme, and an initiator, wherein the composition is disposed on one or more sensor electrodes and cured in the presence of sunlight or UV light.

12. A diffusion-limiting hydrogel membrane system comprising:
a) a first layer comprising an analyte responsive enzyme; and
b) a second layer comprising a water-soluble monomer composition,
wherein the first layer is in direct contact with one or more sensor electrodes and the second layer is in direct contact with the first layer.

13. The membrane system of claim 12, wherein the analyte is selected from the group comprising glucose, acetoacetate, ammonia, catecholamines, creatine, creatinine, fructose, galactose, β-hydroxybutyric acid, bilirubin, lactate, lactic acid, amino acids, urea, uric acid, salicylates, pH, magnesium, calcium, lithium, lead, potassium, sodium, chloride or iron.

14. A diffusion-limiting hydrogel membrane for filtering an analyte from a fluid, comprising:
a) a first layer comprising an analyte responsive enzyme; and
b) a second layer comprising a water-soluble monomer composition,
wherein the first layer is in direct contact with one or more sensor electrodes and the second layer is in direct contact with the first layer.
